(19) United States
(12) Patent Application Publication
(10) Pub. No.: US 2022/0341594 A1
(43) Pub. Date: Oct. 27, 2022

(54) Ignition concept and combustion concept for engines and rockets; most effective or directed excitation, ignition and combustion by means of adapted electromagnetic radiation or electromagnetic waves (e.g. radio waves, microwaves, magnetic waves) and catalytic absorbers to increase the energetic efficiency and thrust

(71) Applicant: Mathias Herrmann, Erfurt (DE)

(72) Inventor: Mathias Herrmann, Erfurt (DE)

(21) Appl. No.: 17/653,910

(22) Filed: Mar. 8, 2022

(30) Foreign Application Priority Data
Mar. 10, 2021 (DE) DE 102021001272.0

(51) Int. Cl. F23Q 11/04; F23Q 13/00; F02K 9/95

(52) U.S. Cl. CPC F23Q 11/04; F23Q 13/005; F02K 9/95; F05D 2260/99; F05D 2300/143; F05D 2300/603

(57) ABSTRACT

Self-ignited burns can be increased by stimulation. External ignition must often be carried out in the combustion chamber. Often an ignition nucleus is formed electrically. This has energetic disadvantages. Required internals can be disadvantageous. Ignitions with plasma torches also need fixed internals. Electromagnetically, however, the ignition field can be widened, the combustion rate increased and the temperature changed. Due to high electrical consumption, this effective ignition has not yet been advantageous for aerospace applications. This concept should be feasible with low electrical energy requirements.

Sufficient electrical energy can be provided by turbopump, generator or thermocouple. For better coupling of electromagnetism, catalytic absorbers and possibly other particles are used. These lower the activation energy. Contactless ignition can be achieved using ceramics or metallic antennas. Ignition in the center of the combustion chamber at the highest pressures is particularly promising. The aim is to achieve combustion that is as directional as possible.

### CROSS REFERENCE TO RELATED DOCUMENTS

The present application claims priority to provisional patent application number DE 10 2021 001 272.0 filed on Mar. 10, 2021 in Germany, disclosure of which are intercorporate herein at least by reference.

no patent literature:
[1] https://www.physikdidaktik.uni-osnabrueck.de/fileadmin/user_upload/Artikel %20Berger/Berger2002a.pdf vom 03.03.2022: DAS MIKROWELLENGERÄT-EIN INTERESSANTER KÜCHENHELFER
[2] Prof Messerschmid, Ernst et al: Raumfahrtsysteme, 4. Auflage, Springer Verlag 2011, ISBN 978-3642-12816-5
[3] https://www.electronenergy.com/samarium-cobalt-magnets/vom 03.03.2022
[4] www.ufz/index.php?de=37415 vom 24.02.2021
[5] Halbedel, B. et. al.: Absorbermaterialien für Hochfrequente elektromagnetische Felder auf Basis von modifizierten Bariumhexaferritpulvern; Thüringer Werkstofftag 2010
[6] https://www.konstruktionspraxis.vogel.de/neuartiges-pulver-absorbiert-mikrowellen-a-151254/vom 28.02.2021
[7] Jing Sun et. al.: “Review on Microwave-Matter Interaction Fundamentals and Efficient Microwave-Associated Heating Strategies”; Materials 2016, 9, 231; www.mdpi.com/journal/materials
[8] https://www.t-online.de/auto/technik/id_67616388/diesotto-neues-vom-selbstzuender-benzinmotor.html vom 03.03.2022
[9] https://motor.at/tests/mazda-skvactiv-x-was-bei-dem-revolutionaeren-motor-verbessert-wurde/401467663 vom 03.03.2022
[10] Stuart James Barkley (Dissertation): Microwave enhancement of energetic materials combustion through gas-phase flame interactions; Iowa State University; 2020
[11] Kline et. al.: Spatially focused microwave ignition of metallized energetic materials; Journal of Applied Physics 127, 055901, 2020
[12] https://physik.cosmos-indirekt.de/Physik-Schule/Gleichraumprozess vom 03.03.2022
[13] https://mwi-ag.com/technik/vom 19.02.2021

### BACKGROUND OF THE INVENTION

### Field of the Invention

The present invention relates to the field of aerospace, including the optimization of ignition and combustion and relates more particularly to methods and devices for optimizing chemical combustion.

### Discussion of the State of the Art

In chemical jet engines and engine systems, ignition is one of the most important technical parameters. This is expressed, for example, in the combustion triangle. For chemical jet engines and engine systems, a fundamental distinction must be made between self-ignition and spark ignition. In the field of air-breathing engine systems, continuous spark ignition is of greater importance. In the case of rocket engines, self-ignition with a change of state that is as isobaric as possible has become established. For initial and re-ignition, one-time ignitions can support e.g. electrical or chemical. Furthermore, in the field of cyclic combustion engines, there have been repeated attempts to combine the advantages of spark and self-ignition (e.g. Skyactiv-X [8] or Diesotto [9]). In cyclic internal combustion engines, self-ignitions (compression ignitions) are more controllable. Thus, diesel engines have a higher effective efficiency than gasoline engines. Although gasoline engines have a higher theoretical efficiency than diesel engines at the same compression ratios due to theoretical equal-space combustion [12].

Fuels (e.g. in the automotive sector) or aerospace propellants often have to be spark ignited in the combustion chamber. Different types of ignition are used. A common type of ignition is by means of electric spark plugs. Here, under suitable conditions, an ignition nucleus is formed (e.g., if there is an ignitable mixture at the electrode). The ignition nucleus grows in laminar phase in the combustion chamber. The pressure wave often travels ahead of the flame front and is reflected at the combustion chamber wall. The pressure and flame fronts can meet again and interfere with the reaction, often resulting in efficiency losses and pollutants [e.g. EP 3 064 767 A1]. Only with subsequent turbulent combustion is the chemical energy more effectively converted into kinetic energy. In the automotive sector, research and work is being carried out for improved ignition using microwaves. Ideally, early space ignition should be achieved to enable a higher proportion of turbulent combustion (e.g. patent specification EP 3 064 767 A1 of Micro Wave Ignition AG). For combustion engines, patent specification DE 198 02 745 C2 claims ignition by microwaves by means of excitation of several modes (or local field strength increases) with partly higher and lower order (e.g. whispering gallery modes). The patent specification refers to microwaves doubling the flame speed near the lean limit in fuel mixtures. This is attributed to microwave heating causing a higher flame temperature. From this, the patent specification concludes that with lower combustion temperature under microwave influence, the flame speed and thus effectiveness can be increased. A higher flame speed means a higher proportion of turbulent combustion. According to [13], the combustion temperatures that can already be achieved in internal combustion engines with microwaves are already 60-120 K below those of conventional spark ignition. According to patent specification EP 3 064 767 A1, a “colder” combustion with increasing combustion efficiency takes place with faster combustion due to improved ignition.

In electric engine systems, a magnetic field is often directed at the fuel or gas to accelerate it in a specific direction in the engine (especially in magnetoplasmadynamic engines). For this purpose, ohmic heating is used in the subsonic range. Ohmic heating, or any type of heating, has a tendency to accelerate, but is non-directional. In addition, engines with an external magnetic field (Hallion accelerators) have already been flight-tested in Russia. These use gases and metals as propellants for acceleration. However, the gases (e.g. xenon) and metals are not ignited.

With permanent magnets made of aluminum-nickel-cobalt, or e.g. Sm₂Co₁₇ (rare earth metals) made of samarium and cobalt, operating temperatures of the magnetic materials of about 500° C., or 773 K, are possible [3].

In the aerospace sector, there are approaches to ignite once by means of microwaves (patent specification AU 2016 259 366 A1, patent specification CA 000 00 26 25 789 C2). Materials such as ceramics can be used to shield the combustion chamber from the antenna or waveguide. These materials are predominantly transparent to microwaves and can be used for higher temperatures at the same time. In contrast, metals shield or reflect microwaves above a certain layer thickness.

According to [5], special absorber materials with modifiable electromagnetic properties are of interest (e.g. hexagonal ferrites). These materials have a high absorption capacity of microwaves.

In patent specification WO 2007/101646 a coated paper for material testing and processing by microwaves is named. This paper is coated with ferrite powder.

For the use of metal parts in the combustion chamber, ternary systems/Triergol systems are known for liquid rocket engines (oxidizer, reducing agent and metallic component/s). These ternary systems/triergol systems use metal parts to increase thrust. In vehicles, metals are also used in fuels as homogeneous catalysts, or additives. Patent specification WO001995004119A1—FUEL ADDITIVES points out that iron and manganese, or copper, can cause damage to the automotive engine. Therefore, the patent specification prefers alkali/alkaline earth and rare earth metals. These are introduced in dissolved form (Lewis bases).

In aerospace, safe ignition even at higher altitudes or in thinner air is also a special challenge. The patent specification GB 000000805400A refers to the fact that the flame front has to be stabilized. In some cases, heterogeneous catalysts are used in electrical ignition systems to reduce the required ignition energy (e.g. patent specification U.S. Ser. No. 02/008,0264372 A1).

In the patent specification DE 39 03 602 A1, reference is made to the fact that combustion processes can be favorably influenced by registered electromagnetic waves and that turbulence can be reduced. Electromagnetic coils at the nozzle throat or outlet area are intended to protect the engine against excessive temperatures. The combustion plasma is partially ionized and therefore conductive or suitable for this purpose. However, this does not affect the ignition process.

In [7] it is stated that absorbers for microwaves can be used as support or carrier for catalysts or catalytic microwave reactions in general. For example, carbon materials that can be loaded with metallic components are cited for this purpose. Environmental remediation, reforming, pyrolysis, and biosynthesis are specifically mentioned as potential applications. Other parts of the source also elaborate on materials processing. However, it is not stated that the absorbers themselves can be catalysts. Or that these combinations are used in oxidic combustion reactions. In particular, the combination of carbon and catalysts mentioned in [7] can, in the worst case, lead to premature coking/fouling of the catalysts.

According to [11], the ignitability by microwave radiation of nanoparticles made of aluminum is relatively poor, but the burning rate is relatively high. Conversely, the ignitability of nanoparticles made of titanium is good in comparison, especially in an oxygen environment. However, the burning rate of titanium particles is not considered to be as high. In contrast, the burning rate is reported to be high for aluminum, but ignitability could not be demonstrated with the paramaters used.

### Disadvantages of the State of the Art

In commercial aviation, the ignition processes are crucial for economical and environmentally friendly operation, especially in turbofan engines. Ignition requires additional internals in the combustion chamber (e.g. flame holders, igniters or flame tubes). These internals cause additional resistances and worsen the thermodynamic conditions (e.g. pressure losses).

In aerospace applications (e.g., rockets), the overall system for vertical launches is designed for a few minutes of burn time. Currently, only a few percent payload share of the total launch mass can be spent in low Earth orbit. Therefore, even small increases in effectiveness can have promising effects on the potential payload fraction.

Essential for a high-performance engine according to the current state of the art is the highest possible combustion chamber temperature and the highest possible combustion chamber pressures.

For aerospace applications, high activation energy is required for the most complete space ignition. For microwaves, this can lead to high electrical powers that are difficult to realize practically. Continuous combustion processes in large geometries, such as jet/rocket engines, convert significantly larger mass flows compared to discontinuous reciprocating engines. These mass flows can be several orders of magnitude higher. A reduction in the necessary activation energy by homogeneous catalysts remains unused for this purpose. In particular, the short residence times of the air mass flow and the fuel in combustion chambers of air-breathing engine systems make further measures necessary. These measures are necessary for successful ignition and also effective excitation by electromagnetic waves (e.g. by microwaves). In jet engines, for example, the usable dwell times for ignition and subsequent combustion are only a few milliseconds and greater spatial dispersion. At the same time, the required power of the electromagnetic waves (e.g. microwaves) must be limited, e.g. to minimize the energy supply to be provided. Maximizing the ignition and combustion time leads to an enlargement or an extension of the combustion chamber. This results in efficiency losses. Energetic losses could result, for example, from increasing friction/heat losses, losses due to expansion and combustion at reduced pressure in the combustion chamber. The weight would also increase adversely.

In addition, combustion according to the state of the art acts on all sides, i.e. pressure is built up on all sides in the combustion chamber. Ultimately, only the proportional flow pressure in the thrust direction of the engine is directly converted into usable thrust. The remaining reaction energy released (e.g. temperature, pressure on all sides) is converted as far as possible into usable thrust by lossy energy conversion. This reduces the amount of energy in the direction of thrust.

Since catalysts are important for ignition (reduction of activation energy), the state of the art of catalysts with regard to ignition must also be taken into account. The combustion rate of ongoing reactions can also be influenced in this respect. In general, however, ignition systems and catalysts are considered separate parts of the combustion process. In jet engines, however, high ignition energies are required continuously, depending on the engine concept. High electrical powers are required to provide these ignition energies, in particular due to only partial absorption of the microwave power by the propellant (e.g. RP1/kerosene) and, in some cases, low residence times of the propellants in the combustion chamber. However, low residence times of the propellants in the combustion chamber are again required for high engine performance. Therefore, chemical systems or flame holders are often used for high-performance and ongoing ignition. In addition to self-consumption, this can also result in energetic flow losses due to internals. In addition, not every ignition location can be reached with contact ignition. However, in air-breathing engines, for example, midstream ignition can be more advantageous in terms of energy.

In the aerospace sector, electromagnetic absorber materials have so far only been researched and tested as energetic materials (metals) directly with electromagnetic waves. However, these energetic metals with their own calorific value predominantly require relatively high electrical ignition powers and effective times. In addition, the valuable catalytic surfaces are damaged and destroyed by preliminary melting/sintering and burning.

### Task of the Invention

The task of the invention is to contribute to improved combustion kinetics with maximum:

0. ignition preparation

1. space ignition

2. flame velocity

3. energy fraction in the direction of thrust

It is also intended to influence the effective combustion temperature.

The task is thus to be solved by the greatest possible interaction of the electromagnetic waves, taking into account reduced activation energy. For this purpose, further possibilities of electromagnetic waves (e.g. microwaves, radio waves), or magnetic fields in direct combination with catalysts are used. Further addition of other catalysts, e.g., in a combined composite fiber may be promising (FIG. 2). If necessary, different electrochemical voltages, different magnetic or electrical properties can be used for improved absorption. Power supply is possible through electric generators at the turbopump, or thermocouples attached to the engine.

To 0. Preparation of ignition:

A prerequisite for fast and uniform ignition is the mixing of the fuel components (oxidizing agents, reducing agents and, if necessary, catalysts). Ejectors, multi-way nozzles or mixing chambers, or mixing areas, can be used for mixing. In these areas, entropy, i.e. disorder, increases. The mixture of substances can also be excited for the first time before entry (e.g. microwaves, magnetic waves). The mixing can be done in pre-mixers whose geometry is adapted to the wavelength of the microwaves.

To 1. space ignition:

Microwaves can lower the combustion temperature and increase the flame speed (e.g. according to patent specification DE 198 02 745 C2).

Space ignition is achieved by the above-mentioned combination and optimized as far as possible. Named are electromagnetic waves and the lowering of the activation energy via catalysts. Preheating of the catalytic absorbers, possibly preheating of used solutions, pyrotechnical ignition aids, antifreeze, wetting agents, etc. can also be advantageous.

To 2. flame velocity:

The use of catalytic components (e.g. particles or catalytic solutions) can lower the required power of the microwaves and, if catalytic components are used, lower the activation energy or further increase the following reaction rate.

Metals (e.g. catalysts) generally reflect microwaves and heat up only superficially. However, in particular, the following mechanisms of action, among others, can be used to absorb microwaves within the framework of this ignition concept:

I. According to [1] on microwaves, there is a large number of free-moving charges in metals, but microwaves can generally penetrate only a few micrometers at most [7] and the absorbed energy portion (heat) is distributed by the good thermal conductivity of the metal→i.e., however, in thin metal foils, for example, this heat input is relevant

II. reflections from metal parts and oscillations of the moving charge carriers (electrons) can lead to resonances and field peaks with high energy density and ultimately heat inputs, or sparkovers can be formed

III. heated metal parts are ionized/polarized, this can lead to plasma formation (can have a detrimental effect, e.g. on combustion chamber walls)

IV. Metal parts which are present in polarized compounds, e.g. dissolved/ionized in liquids are also heated up

V. homogeneous catalysts which

a. interact with fuel components, e.g. polar bonds are heated

b. are composed of multiple catalysts (polycatalytic), e.g., fibers with polarized contact sites due to different electrochemical, thermal, electrical, or magnetic properties

c. Alloys/dopants/surfaces where there are irregularities in the electron distribution and where the mobility of atoms is present

VI. combination with other electromagnetic waves for ionization/stepped heating (e.g. magnetic waves, X-ray waves). Microwaves heat in a specifically concentrated and punctual manner, i.e. with a higher degree of efficiency.

Subordinately, the fuel components must also be taken into account with regard to their absorption capacity for electromagnetic waves (e.g. hydrogen, oxygen, methane, RP1/kerosene). In the combustion chamber, the fuel components are additionally ionized due to pressure/temperature and intermediate combustion steps. In addition, fuel components are reactivated and ionized by the addition of catalysts. The absorption capacity of fuel components is also increased by this.

To 3: Energy share in thrust direction:

After deduction of losses, typically 40-70% of the power expended (chemical energy supplied) is available for the actual thrust of chemical engines [2].

For maximum energy in the direction of thrust, combustion that is as directional as possible is advantageous. Transverse reactions generate additional friction, or ineffective pressure on the combustion chamber walls and ultimately the dissipation of energy into heat, or detrimental efficiency losses.

Charge distributions are crucial for effective coupling and ignition by means of electromagnetic waves (e.g. microwaves). Charge distributions in the propellant can result from:
polar compounds (different electronegativity of the bonding partners), e.g. water (H₂O)
weak non-covalent interactions, or Van-der-Waals forces between dipoles e.g. methane (CH₄)
Voltage induction/law of induction (e.g. movement of ferromagnetic materials in magnetic field)
Ionization (dissolution of ions)
Catalysis (binding via electrons to catalyst)
Ionization (e.g. by means of X-rays),
Pressure/temperature-dependent ionization of the ignition mixture (e.g. patent specification EP 3 064 767 A1)

According to patent specification EP 3 064 767 A1, if the absorption of the microwaves is poor, “a considerable part of the power can be coupled back into the feed waveguide and is reflected to the microwave source”.

In order to produce the most effective, or directed, combustion possible, the following tools in particular can be used according to this patent specification:

a) change of the wavelength

b) magnets for ionization/polarization of the compounds

c) Ionization/radiation (e.g. advancing microwaves, or X-rays)

d) In addition to catalysts, additional metallic particles (e.g. if the melting points of the catalysts are exceeded prematurely)—if necessary in a compound (FIG. 2)

To 3. a) Energy fraction in thrust direction, auxiliary wavelength:

Electromagnetic waves (e.g. radio waves, microwaves, X-ray waves) are transverse waves. The oscillation directions are perpendicular to the propagation direction of the electromagnetic waves. This means that electromagnetic waves can cause interference. Waves with opposite oscillations can cancel each other out. Waves with the same vibration directions can add up (up to resonance).

In principle, coupling is possible radially or axially to the flow direction of the engine. Axial means from the direction of injection or the nozzle. Excitation should thus be possible in the direction of flow or in the direction of the nozzle. Complete oscillations can be used here. Radial means from the side of the combustion chamber wall.

In general, for example, an all-sided or multi-sided electromagnetic excitation can lead to a higher temperature and reactivity in the area of ignition, or combustion, due to the increase in movements of the particles. This form of ignition should allow a faster reaction. The electromagnetic energy is concentrated in relation to the flow direction of the engine system. With cooperating catalysts (see 3. d)), the required activation energy can be lowered and the reaction rate further increased. It is also possible to initiate a starting temperature for the following combustion in the combustion chamber with conventional initial ignition. For conventional ignition, electrical or chemical ignition systems can be used, for example. The aim is to achieve as continuous a reaction as possible. Due to the flame front that builds up, the remaining reaction partners are captured with as high and directed a speed/excitation as possible.

To achieve excitation, a wavelength corresponding to the combustion chamber is advantageous (e.g. low-frequency microwave). The reaction partners or particles are rhythmically excited, or preferentially forced in certain directions, or also compressed. The penetration depth or amplitude can be controlled by the frequency of the electromagnetic waves. In this way, the reaction partners can be excited over their entire length, if necessary. The aim is to produce matter waves that are as rectified as possible in the direction of thrust with a reduced reaction component perpendicular to it on the combustion chamber wall, or against the flow of matter. This would reduce the combustion chamber temperature and increase the speed of the flame front.

Also, if necessary, the entire cross-section can be excited uniformly via phase shifts (in the case of radial excitation). Electronic filters can be used (e.g. YIG filter, Gaussian filter, Bessel filter).

In order to achieve a particularly defined coupling of electromagnetic ignition power, the use of a maser is also theoretically possible. “Masers” are “Microwave Amplification by Stimulated Emission of Radiation”, or special lasers for the microwave range. These can also be thermally shielded from the combustion chamber by appropriate ceramics.

To 3. b) Energy component in thrust direction, auxiliary means magnets: Ionization occurs in the propellant at high pressure and temperature conditions.

The following effects are aimed at (due to the induction/increased ionization, or charge distribution):
improvement of ignition due to higher reactivity—increase of reaction rate
improved coupling of electromagnetic waves
reduction of the required electromagnetic power
improved alignment in the ignition process.

Due to the ionization of catalytic components and subordinate other of the fuel triggered by pressure and temperature and the Lorentz force can be used. The propellant is additionally accelerated in one direction to align the combustion. Ionization reaches its maximum in the engine. If the magnetization is appropriate, a voltage can be induced by the law of induction in conjunction with magnets on the engine (e.g. permanent magnets) and the movement of the catalysts in them. The voltage can be used for better coupling of the other electromagnetic waves or for further ionization in other fuel components. Due to the combustion chamber temperature and pressures and the increasing loss of the white areas, a loss of this effect can be assumed with increasing combustion of the components in the engine.

Due to the ionization of catalytic components and, subordinately, of the remaining propellant triggered by pressure and temperature, the Lorentz force can be used. The propellant is additionally accelerated in one direction to align the combustion. Ionization reaches its maximum in the engine. With appropriate magnetization, a voltage can be induced by the law of induction in conjunction with magnets on the engine (e.g. permanent magnets) and the movement of the catalysts in them. The voltage can be used for better coupling of the other electromagnetic waves or for further ionization in other propellant components. Due to the combustion chamber temperature and pressures and the increasing loss of the white areas, a loss of this effect can be assumed with increasing combustion of the components in the engine.

When using permanent magnets e.g. made of aluminum-nickel-cobalt, or e.g. Sm₂Co₁₇ (rare earth metals) made of samarium and cobalt, operating temperatures of the solid magnet materials of approx. 500° C. or 773 K are possible [3]. These magnets can be used, for example, upstream on the lines or, if necessary, cooled downstream on nozzles, or outside on the combustion chamber on electromagnetically permeable materials (e.g. on ceramics). A circulating magnet can also be used on the outside of the engine or nozzle (e.g. thermally shielded by means of ceramics). The homogeneous catalysts can be used as absorbers in the engine in such a way that, after initial magnetic reaction or heating in the engine, the ferromagnetic properties are thermally lost. This means that the order of the Weiss domains is dissolved in the engine. The thruster current can therefore continue unaffected downstream at the nozzle. With appropriate cooling, it can also be used on spray/mix plates or premixers in the combustion chamber. Paramagnetic materials with high catalytic activity can be used (e.g. palladium, rhenium, platinum, vanadium, rhodium, etc.). Ferromagnetic substances in the fuel can also be used, such as compounds of iron, nickel or cobalt, or combinations of these.

To 3. c) Energy portion in thrust direction, auxiliary further electromagnetic radiation:

Advancing, or accompanying electromagnetic radiation (multistage microwave, radio waves, or X-rays) can increase the interaction with microwaves in the ignition phase.

Also, radio waves are energetically particularly efficient in heating [4]. The prerequisite is the possibility of absorption in a fuel component.

To 3. d) Energy share in thrust direction, auxiliary/metallic particles: Metallic particles can be used additionally to support the combustion. The metallic particles do not serve to couple/absorb electromagnetic radiation (e.g. microwaves). However, they can be used energetically. This can be achieved, for example, by appropriate size of the metallic particles (≥several micrometers in diameter). This is because, as explained, electromagnetic radiation (microwaves) is shielded from a certain layer thickness in metals.

For example, a large magnetic fiber structure of magnetic fiber (e.g., iron, nickel, cobalt) can be sintered, fused with highly active catalytic fiber (FIGS. 2 and 3). Thus, the large magnetic fiber does not serve to absorb microwaves. However, the magnetically homogeneous catalyst can be combined with a permanent magnet attached to the outside of the combustion chamber (e.g., on fuel lines, premixer, or nozzle throat) to support the desired directional vector in the combustion chamber and optimize combustion kinetics.

In this way, the combustion process can also be supported downstream. Combustion conditions can be adjusted or burnout increased (e.g., in air-breathing engine systems).

Patent specification U.S. Pat. No. 7,635,461 B2 already proposes a homogeneous catalyst with a multilayer structure, or particles of metals. This has a core of a combustible metal.

In the special field of gas generators for turbopumps, or for turbines, the combustion concept included in the ignition concept can also be advantageous. In this way, the combustion temperature can be lowered, combustion can be made more uniform, e.g. in order to conserve materials. This should increase the performance and service life of combustion chambers and systems.

### SUMMARY OF THE INVENTION

Essential to effective utilization of chemical energy in an engine is combustion kinetics. Due to the energy conversion from chemical to predominantly thermal energy, the oscillations of the reaction products lead to an increase in pressure and volume. Engine and nozzle geometry further convert as much of the thermal energy as possible into kinetic energy and usable thrust.

According to [2], losses during these energy conversions result from:

1. radial velocity component at the nozzle outlet, or divergence losses

2. spatial and temporal non-uniform velocity, so-called profile losses

3. friction losses

4. heat losses to the outside and fuel leakage losses

5. incomplete expansion pe>0

6. incomplete combustion and reactions (i.e. non-equilibrium) in the expansion flow

Essential to an efficient engine in the current state of the art is the greatest possible combustion chamber temperature and greatest possible combustion chamber pressures.

This ignition concept is aimed at achieving the following effects:
increase of the payload fraction in vertical launches of rockets
better utilization of the chemical-bound energy in propellants through more direct conversion into kinetic energy
if necessary, increasing the flame speed in the combustion chamber
possibly reduction of effective combustion chamber temperature, thus less cooling and higher strength of engine parts (less heat stress for materials)—more favorable materials can be used
more uniform combustion, fewer pressure surges
by using homogeneous catalysts as absorbers, deposits/fouling/soot are removed from the combustion chamber, this is advantageous for improving the coupling of the microwaves—this means that the microwaves are coupled in a more stable manner
higher mass flows achievable, reduction of the specific weight of the engine mass
possible contactless and targeted ignition in certain areas of the engine systems (e.g. in turbofan engines, air-breathing engine systems)
if necessary, adaptation of combustion via the profile (e.g. in peripheral areas)
Regulation of combustion kinetics, e.g., outside regular operation (e.g., startup phase and burnout phase, or for support in the event of reduced engine power)
Extending the service life of engine components

### BRIEF DESCRIPTION OF THE DRAWINGS

FIG. 1a shows a diagram of the initial situation.

FIG. 1b presents schematic diagrams of the basic concept of the subject invention.

FIG. 1c presents an illustration of a multistage excitation and ignition system.

FIG. 1d presents a diagram of a magnetic field for acceleration.

FIG. 2 shows a spatial presentation of homogeneous catalysts in a fiber structure with ferromagnetic properties.

FIG. 3 presents a cross-section of homogeneous catalysts in a particulate structure with ferromagnetic properties.

FIG. 4 shows a longitudinal and a transverse diagram of an embodiment with pulsation, or wavelength, and a schematic diagram, respectively.

FIG. 5 shows an illustration in the longitudinal direction to a rocket engine with an electromagnetic stimulation from the side and a schematic illustration to an electromagnetic wave.

FIG. 6 shows a longitudinal presentation of a rocket engine with a ceramic head plate and electromagnetic stimulation from above.

FIG. 7 shows a longitudinal presentation of a rocket engine with an electromagnetic stimulation from the side and shielded permanent magnets at the nozzle throat as well as a schematic presentation of an electromagnetic wave.

FIG. 8 is a longitudinal presentation of an aerospike with a ceramic coupler and includes a cross-section of a combustion chamber.

FIG. 9 presents a longitudinal presentation of a ramjet engine with ceramic coupler from the side and includes a cross-section.

FIG. 10 presents a longitudinal presentation of a Ramjet engine with ceramic coupler in the intermediate body.

The above designs are examples. Further variants are covered in the patent specification or claims (e.g. for generators for turbopumps/turbopumps).

In general, the following applies to chemical engines: The conversion of the chemically bound energy from the reducing agent (4) and oxidizer (5) supplies thermal energy. Furthermore, kinetic energy is obtained by lossy conversion. This is because it is only through the lossy thermodynamic change of state at the nozzle throat and the nozzle that a further part of this thermal energy is converted into kinetic energy in the direction of thrust (7). As a general rule, the reaction is accelerated at a high combustion temperature. The combustion temperature cannot be increased at will (e.g. due to the limited heat resistance of materials on the engine and the increasing cooling requirements).

### DETAILED DESCRIPTION

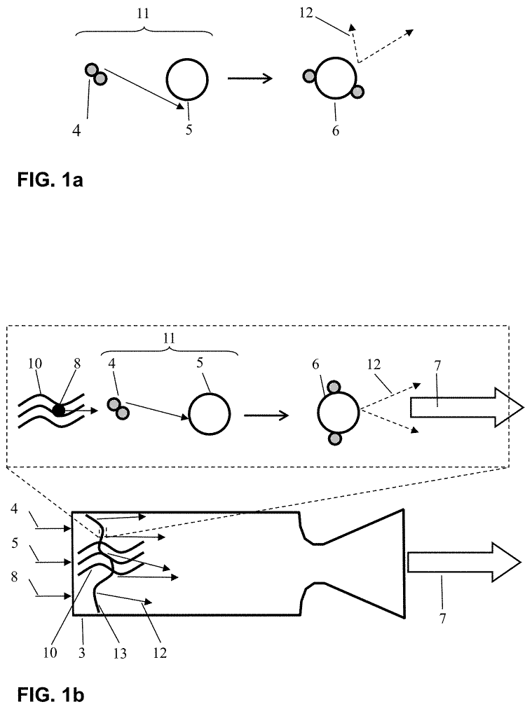

FIG. 1a: Initial situation.

In the reaction, reducing agent (4) and oxidizing agent (5) react in the following reactant (11) by approach/contact. Energy is released by the chemical reaction. The thermal energy is to be understood as the movement of the particles, or the reaction products (6). Reactions take place in different directions (12), since the reaction partners (11) react freely in the combustion chamber.

FIG. 1b: Basic concept.

In this FIG. the basic concept is schematized together with an engine.

Electromagnetic waves (10) (e.g., microwaves, radio waves) can be used to selectively excite, or accelerate, the advancing motions of the catalytic absorbers (8). The catalytic absorbers (8) and the electromagnetic excitation (10) increase the reaction in the thruster system. The reaction directions (12) in the thrust direction (7) are made effective, or increased, by this excitation. Catalytic absorbers (8) are used for improved coupling. At the same time, the required activation energy of the reactants (11) decreases. Reducing agents (4) and oxidizing agents (5) react at increased reaction rates. Reaction products (6) are formed at a higher rate.

The aim is to achieve an overridingly uniform or as uniformly as possible accelerated ignition (13) in the direction of thrust (7). The combustion rate is increased. The average temperature in the combustion chamber (3) can be reduced.

FIG. 1c: Multi-stage excitation and ignition.

With multistage electromagnetic excitation and ignition (13, 16), the mixture of reducing agent (4), oxidizing agent (5) and catalysts (8) in the combustion chamber (3) can be heated more uniformly.

In front of the actual combustion chamber (3), a mixing area (2) can be placed. In the embodiment, mixing areas (2) are arranged to form resonator chambers (15). These are designed to match the wavelengths of the electromagnetic pre-excitation (16).

Reducing agents (4), oxidizing agents (5) and catalysts (8) are introduced into the mixing region (2) via a line system (1). The catalysts (8) may comprise fibers or particles, or a combination thereof. In the embodiment, fine holes are used to introduce the homogeneous catalysts (8). Alternatively, multi-channel nozzles, ejectors, hollow cone nozzles or other nozzles/bores can be used for mixing.

During mixing, the entropy increases and increasing movements are carried out. Electromagnetic excitation by means of microwaves (16) with respect to the direction of thrust causes the components at the end of the mixing zone (2) to be excited again in alignment with the direction of thrust (7) and heated proportionally.

In the combustion chamber (3), the components are ignited by a further electromagnetic excitation (13).

FIG. 1d: Magnetic field for acceleration.

Compared to the embodiment FIG. 1b, magnets (17) are additionally arranged in this embodiment. Magnets (17) (electromagnets in this case) additionally excite the propellant components consisting of reducing agent (4), oxidizing agent (5) and catalysts (8). This means that the propellant components are accelerated and ionized/or voltages are induced. Cations (18) and anions (19) are formed. This is advantageous for the electromagnetic waves (10), e.g. microwaves, since coupling of the radiation power is facilitated. In addition, the reactivity in the combustion chamber (3) increases and the kinetic power in the direction of thrust (7) is increased.

Coupling takes place predominantly through the catalytic absorbers (8).

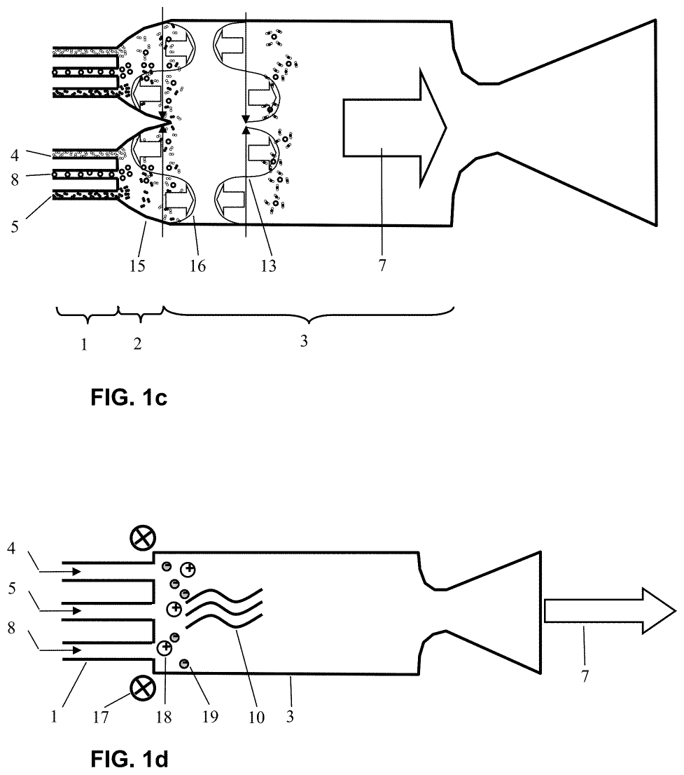

FIG. 2 Homogeneous catalysts fiber structure with ferromagnetic properties.

In this embodiment, homogeneous catalysts are shown as absorbers in a fiber-like structure (20).

Individual fibers are bundled together to form a fiber-like structure (20). In order to specifically incorporate ferromagnetic properties, a ferromagnetic fiber (21) e.g. made of compounds of iron, nickel, cobalt is combined with a catalytic fiber (22) as absorber. The catalytic fiber (22) can be constructed of gold or an alloy containing gold (e.g. with silver or platinum). Due to the relatively high cost and maximum permissible penetration depth of the catalytic waves (microwaves), the catalytic fiber (22) has a thickness of only about 1 μm at most. The ferromagnetic fiber (21) is not designed to couple electromagnetic power due to its larger size. Other catalytic fibers (23) with different electrochemical, thermal or e.g. electrical properties can also be used specifically to supplement the catalytic absorber (22).

Advantages result from this structure. In conjunction with external electric generators, the magnetic and catalytic structures can induce a voltage at the combustion chamber for supply by means of electrical energy. The voltage is induced by movement of the magnetic structures in the combustion chamber (law of induction). Or, conversely, the magnetic and catalytic structures can be selectively accelerated, or ionized, to accelerate the reaction in the combustion chamber. In addition to the catalytic effect, or increased catalytic effect.

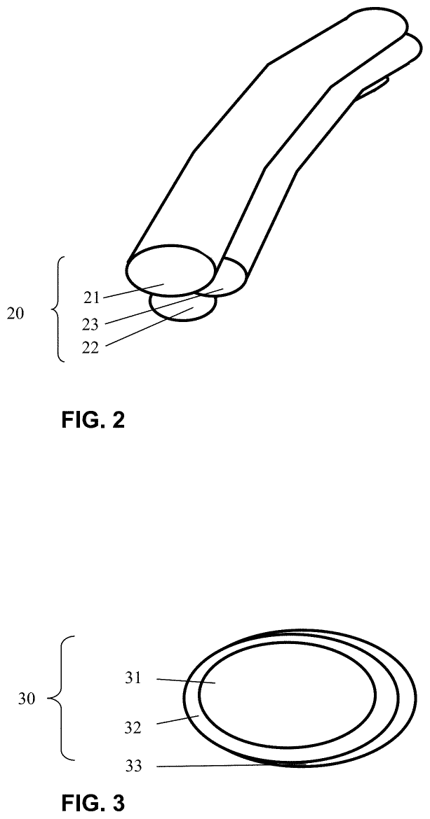

FIG. 3 Homogeneous catalysts.

Particle Structure with Ferromagnetic Properties

In this embodiment, a homogeneous catalyst with a non-energetic but ferromagnetic core (31) is shown.

The particle (30) is formed in the core (31) from a ferromagnetic body

(e.g. compounds of iron, nickel, cobalt). A catalytically active material (32) is applied in a layer around the core (31) (e.g. platinum, rhenium, palladium, gold, rhodium). Additional layers of alternative catalytic material (33) may also be added. The larger core (31) does not serve as an absorber for microwaves because it is shielded by the catalytic layer (32). This also results in thermal inertia, which temporarily protects the magnetic properties.

Advantages result from this structure. In conjunction with external electric generators, the magnetic and catalytic structures can induce a voltage at the combustion chamber for supply by means of electrical energy. The voltage is induced by movement of the magnetic structures in the combustion chamber (law of induction). Or, conversely, the magnetic and catalytic structures can be accelerated or ionized in a targeted manner. In this way, the reactions in the combustion chamber can be accelerated or aligned and the thrust of the engine increased.

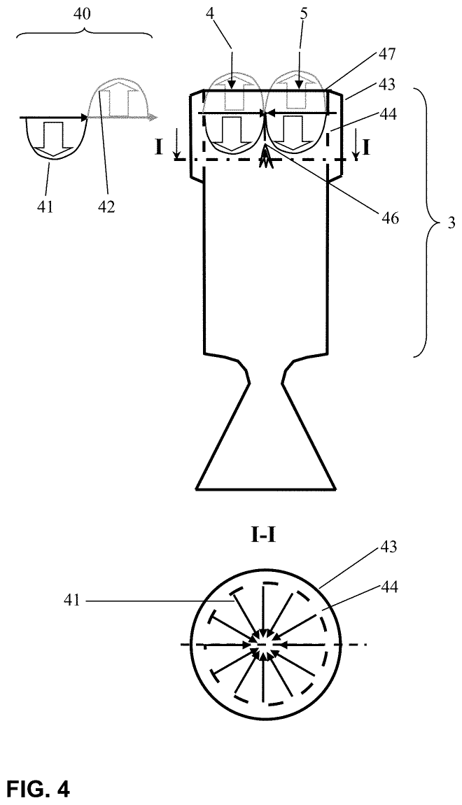

FIG. 4: Pulsation, or wavelength.

In this embodiment, a rocket engine system is shown.

In principle, excitation by electromagnetic radiation (e.g. microwaves, radio waves) occurs over the entire oscillation (40), since this is perceived as electromagnetic waves. I.e. there is a deflection in both vibration directions. The magnetic oscillation is not decisive in this embodiment.

In the direction of thrust is excited by electromagnetic oscillation (41). The countermovement (42) is used for contact/compression with reaction partners to reduce the escape of the released chemical energy via the walls of the combustion chamber (3). The width of the combustion chamber (3) is selected to create a wavelength. A larger cross-section can also be selected by opposite coupling. Also, any multiple of the wavelength can be used.

Alternatively, for smaller engines, a combustion chamber cross section with half a wavelength can be used for excitation. To prevent feedback into the feeder/waveguide (43), the feed can be rotated by a few degrees so that the electromagnetic waves propagate in the combustion chamber.

Theoretically, radio waves with a longer wavelength and more efficient heat transfer can also be used.

An electric igniter (46) can be placed in the combustion chamber (supporting redundant system) to start combustion and additionally control the combustion chamber temperature in the start phase.

A feeder, transmitter, or waveguide (43) for coupling the electromagnetic oscillations (41 and 42) is arranged around the combustion chamber (3) near the head plate (47). The electromagnetic oscillations (41 and 42) are fed into the combustion chamber (3) via a ceramic coupler (44). The ceramic coupler (44) is electromagnetically permeable. The electromagnetic oscillations (41) are fed in the circumferential direction, i.e. rotationally symmetrically.

The catalyst (8) in particular, but also to a lesser extent the reducing agent (4) and the oxidizer (5), are energetically excited (thermally) in the desired direction by excitation. Alternatively, the combustion chamber (3) can also be excited with an adapted wavelength. If necessary, radio waves with a higher frequency can be used.

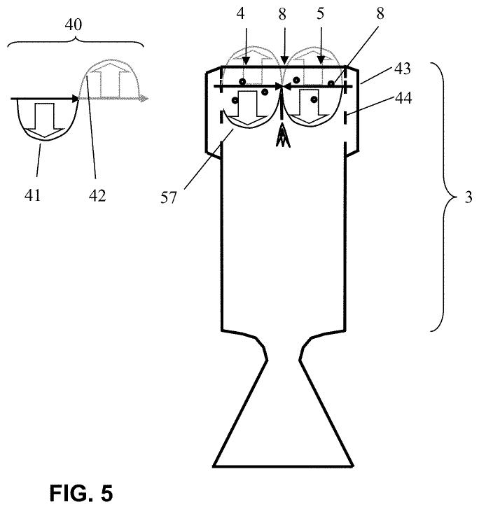

FIG. 5: Rocket engine stimulation from the side.

Compared with FIG. 4, in this embodiment catalysts (8) are additionally injected into the combustion chamber (3). Due to the high energy absorption during electromagnetic excitation (57), thin-layer metals (maximum layer thickness of a few micrometers) of the catalysts (8) are strongly heated and accelerated.

The metallic catalysts (8) are additionally thermochemically activated by the excitation (57) and thermal heating. This means that the catalytic activity increases.

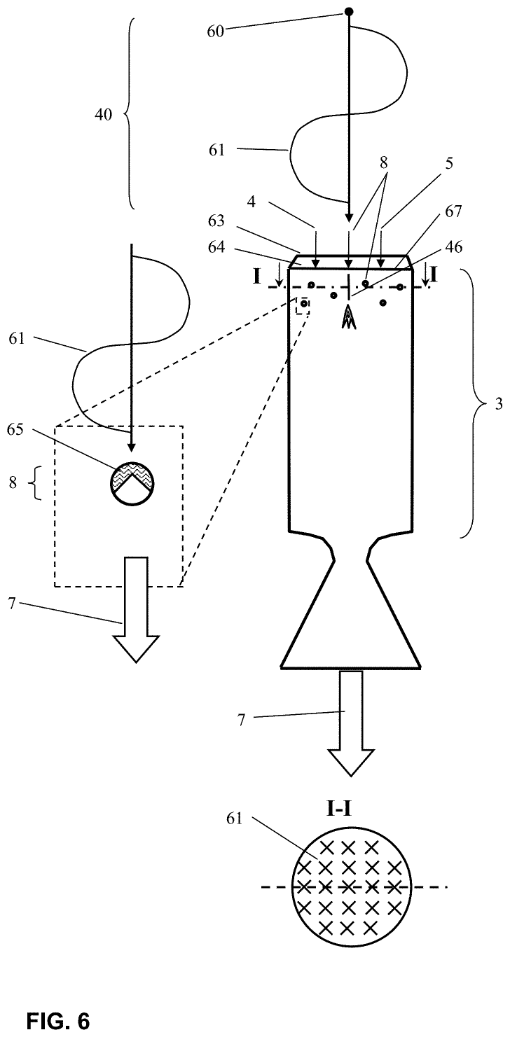

FIG. 6: Rocket engine ceramic head plate, stimulation from above.

Compared to FIG. 5, in this embodiment the electromagnetic oscillations (61) are introduced from the direction of injection of the reducing agent (4), oxidizer (5) and catalyst (8) in the direction of thrust (7).

The radiation source (60) is arranged above the head plate (67) of the combustion chamber (3). The electromagnetic waves (61) are guided in a waveguide (63), or in front of an electromagnetically permeable layer (64). Electromagnetic waves (61) are coupled into the combustion chamber (3) through the electromagnetically permeable layer (64), e.g. made of a ceramic.

The direction of oscillation is perpendicular to the direction of thrust (7). The oscillation is carried out completely. This causes the particles to be excited alternately transversely in the direction of motion.

By selecting an appropriate frequency with reduced penetration depth, or larger absorbers (8), the particles are detected on one side towards the radiation source, i.e. excited on one side (65). Since the oscillations are carried out transversely to the direction of thrust (7), the effects predominantly cancel each other out, and heating occurs. The heating is toward the radiation source. A pressure gradient is created in the direction of thrust (7).

An electric or chemical igniter (46) can be placed in the combustion chamber (3) to start combustion or to additionally control the combustion chamber temperature in the start phase (supporting redundant system).

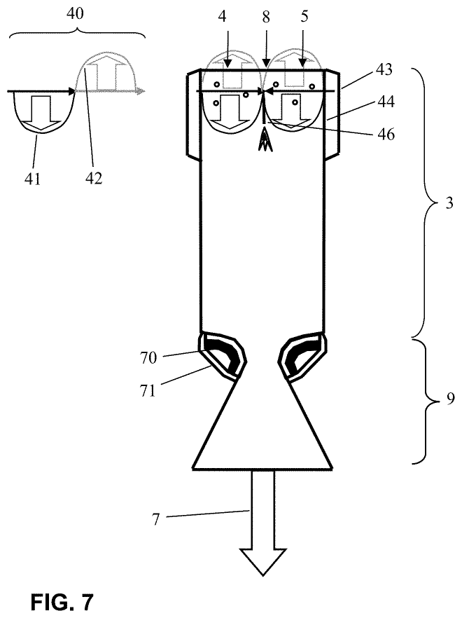

FIG. 7: Rocket engine excitation from the side and shielded permanent magnets at the nozzle throat.

Compared to FIG. 6, in this embodiment permanent magnets (70) are arranged at the nozzle throat (e.g., made of aluminum-nickel-cobalt or samarium-cobalt). The permanent magnets (70) exert an attraction on the catalytic absorbers (8), which are designed as a composite structure (FIG. 2). The composite structure is supplemented by ferromagnetic components. The catalytic absorbers (8) additionally have a ferromagnetic fiber (compounds e.g. of iron, nickel, cobalt) next to the fiber of highly active catalysts (e.g. platinum, palladium, rhodium, rhenium, gold, molybdenum). The catalytic absorbers (8) with ferromagnetic components are attracted to the permanent magnets (70). The direction of flow of the catalytic absorbers (8) is guided, controlled and accelerated in the direction of thrust (7). In the combustion chamber (3), the catalytic absorbers (8) lose their ferromagnetic properties due to the temperature and reaction even before they reach the nozzle (9). This allows the reaction products to escape unaffected through the nozzle (9) with the rest of the engine flow. The permanent magnets can be antimagnetically shielded (71) from the outside, e.g. to protect the other systems and electrics.

Alternatively, attraction by means of electromagnets is possible. For this purpose, the energy from external coils on the combustion chamber or the turbopump can be used. The magnets can also be arranged in the area, e.g., on upstream ejectors, mixing chambers, combustion chamber head, etc.

To start the combustion, or to control the combustion chamber temperature additionally in the start phase, an electric or chemical igniter (46) can be placed in the combustion chamber (supporting redundant system).

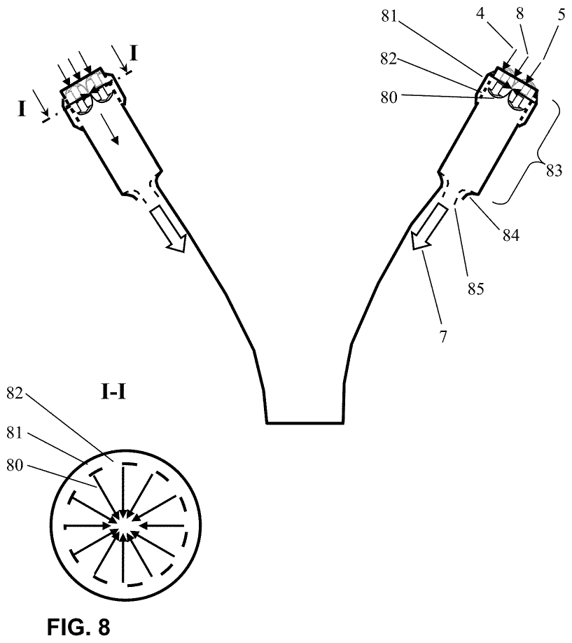

FIG. 8: Aerospikes ceramic coupler.

Aerospikes are shown in this embodiment variant.

The embodiment is designed according to FIG. 5 with electromagnetic couplers (82) on the side of the combustion chamber (83). Waveguides, or transmitters (81), are arranged accordingly around the circumference, which feed into the combustion chambers (83) via electromagnetically permeable couplers (82). The permeable couplers (82) are made of ceramic, for example.

The combustion chambers (83) are located opposite the nozzle neck (84) of the aerospikes. The electromagnetic excitation takes place in the direction of thrust (7).

The electromagnetically excited reaction of reducing agent (4), oxidizer (5) and catalysts (8) aims at a low combustion temperature at high exit velocity. The aim is to improve cooling of the aerospikes, in particular of the respective nozzle throat (84). The aim is to achieve a nozzle throat (84) with reduced necking. This can be achieved, for example, by greater reaction speed with higher mass flow. The necking of a conventional design (85) is indicated for comparison.

An electric or chemical igniter can be placed in the combustion chamber (redundant system) to start the combustion or to additionally control the combustion chamber temperature in the start phase. This is not shown in this design variant.

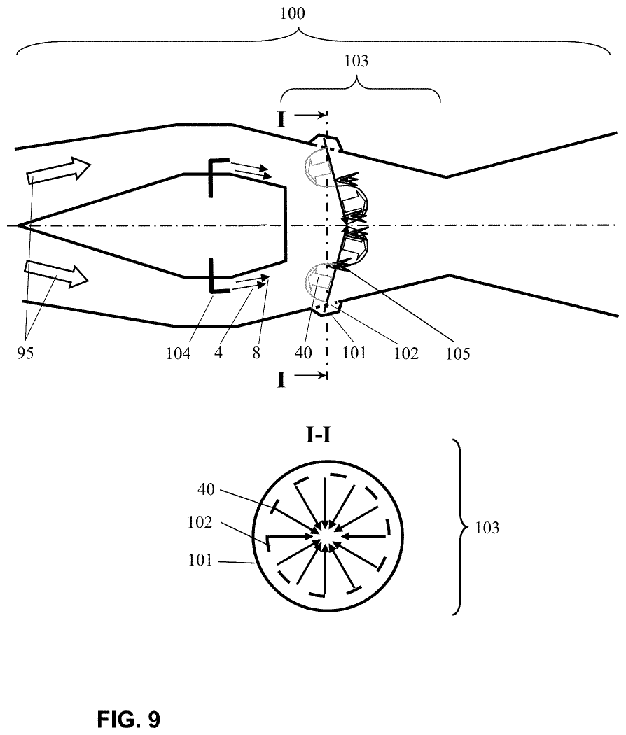

FIG. 9: Ramjet engine ceramic coupler from the side.

In this embodiment, an air-breathing engine with subsonic combustion is shown (ramjet).

The incoming air mass flow (95) serves as an oxidizer. Reducing agents (4) and catalytic absorbers (8) are injected into the air mass flow (95) through injectors or nozzles (104). In the ramjet engine (100), only a short time can be used for ignition (105) and combustion in the combustion chamber (103). Therefore, the combination of electromagnetic waves (40) such as microwaves with catalytic absorbers (8) is provided to inject highly active ignition nuclei into the combustion chamber (103). The combustion chamber length is to be limited to minimize friction losses.

Appropriately directed electromagnetic waves (40) (e.g. microwaves) make it possible to ignite from the outside without internals in the combustion chamber and eliminate aerodynamic resistance (e.g. from plasma flames). Electromagnetic waves (40) also offer the possibility of covering further ignition ranges (105) with more uniform combustion. Ignition areas (105) are created at maximum compression, which cannot be reached with internals, or only with difficulty (e.g. in the center of the combustion chamber).

The electromagnetic waves (40) are coupled into the combustion chamber (103) via a transmitter, e.g. a rod antenna or waveguide (101), and an electromagnetically permeable layer (102), such as a ceramic. The remaining area of the combustion chamber (103) is electromagnetically reflective to form a resonator cavity for the electromagnetic waves (40).

For the electrotechnical supply of the electromagnetic waves (40), thermocouples on the combustion chamber or outer skin, electric generators on the turbopump of the fuel supply, or electric generators on the engine duct are possible. The electric generators on the engine can be fed by induction during the movement of the catalytic absorbers (8) in the engine duct. Any additionally added metal parts or ionized combustion gases are also relevant.

To start the combustion, or to additionally control the combustion chamber temperature in the start phase, an electrical or chemical igniter can be placed in the combustion chamber as an alternative or supplement (supporting redundant system). This is not shown in this embodiment.

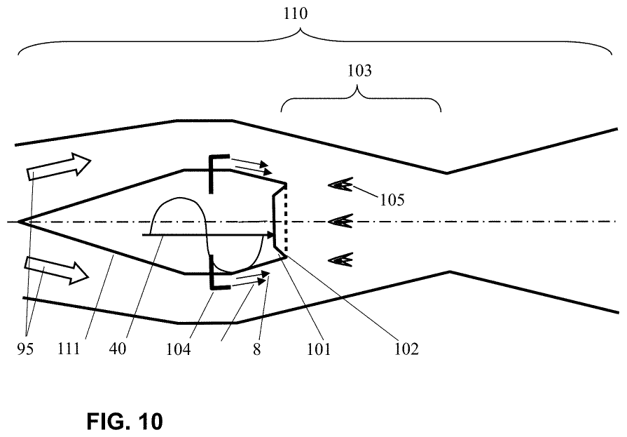

FIG. 10: Ramjet engine with ceramic coupler in intermediate body.

Compared to the embodiment of FIG. 9, at the Ramjet engine the electromagnetic waves (40) are coupled in by the intermediate body (111). The electromagnetic waves (40) are injected in the direction of flow.

For this purpose, corresponding devices are arranged on the downstream side of the intermediate body (111). The intermediate body (111) contains a transmitter, e.g. a rod antenna or waveguide (101), and an electromagnetically permeable layer (102), such as a ceramic, for coupling into the combustion chamber (103).

What is described herein are specific examples of possible variations on the same invention and are not intended in a limiting way. The invention can be practiced using other variations not specifically described above.

What is claimed is:

1. A method without using electromagnetic light waves and for at least one of the following processes in chemical combustion processes: Excitation or ignition, in which at least one of the aforementioned processes is used with at least one liquid propellant component in at least one of the following effective areas: before a combustion chamber (e.g. rocket engine, gas turbine, or gas turbine for turbopump), in a combustion chamber (e.g. rocket engine, gas turbine, or gas turbine for turbopump), after a combustion chamber (e.g. rocket engine, gas turbine, or gas turbine for turbopump), before a combustion chamber (turbine engine, pulse jet engine, ramjet), in a combustion chamber (turbine engine, pulse jet engine, ramjet), after a combustion chamber (turbine engine, pulse jet engine, ramjet) comprising:
a variable energy input with at least one coupling of electromagnetic waves (e.g. microwaves, radio waves, X-ray waves) is used in at least one combustion-free catalytic absorber or catalytic absorber convertible by means of endothermic reaction for combustion of the remaining propellant components.

2. A method according to claim 1 comprising:
In that at least one absorber as homogeneous catalyst consists of at least one element of the platinum group metals or noble metals (excluding Cu).

3. A method according to claim 1 comprising:
In that the homogeneous catalyst is designed as a composite structure (e.g. fiber composite or particle composite).

4. A method according to claim 1 comprising:
In that the electromagnetic absorption is selectively enhanced by at least one difference of the constituents in the following properties in a composite structure: electrochemical properties, thermal properties, electrical properties, photo-catalytic properties, porosity for electrolytes.

5. A method according to claim 1 comprising:
Characterized in that at least one electromagnetic absorber is introduced into the chemical combustion process distributed in a solution, in which the solution has at least one of the following properties: oxidation-inhibiting effect, wetting properties, amphoteric properties, inducing ignition delay, exhibiting knock-inhibiting effect, freezing point lowering properties, exhibiting electrolytic properties.

6. A method according to claim 1 comprising:
In that a multilayer homogeneous catalyst is designed with a ferromagnetic core shielded against electromagnetic heating.

7. A method according to claim 1 comprising:
In that at least part of the propellant is magnetized or magnetizable (e.g. as ferrofluid).

8. A method according to claim 1 comprising:
Characterized in that the coupling of said electromagnetic power in at least one direction or at least one particular region of the mass flow is enhanced by at least one of the following devices: Use of an electrical filter (e.g. YIG filter, Gaussian filter, Bessel filter), pulsing of the electromagnetic waves, use of a polarization filter, use of a microwave laser, use of a maser, unilateral excitation of the absorbers, magnetic alignment of the absorbers, magnetic acceleration of the absorbers.

9. A method according to claim 1 comprising:
Characterized in that, in order to further reduce the required activation energy by means of electromagnetic waves for a named chemical process, at least one of the following methods is used: Preheating of the absorbers, preheating of the solution, adherent pyrotechnic agents, adherent phosphorus-containing component, multistage feed, increased heat reflection of the combustion chamber walls e.g. by means of coating of platinum or gold compounds, aligned heat reflection of the combustion chamber walls e.g. by means of spatially inclined coating of platinum or gold compounds.

10. A method according to claims 1 comprising:
Characterized in that in the composite structure of fibers attached energetic components are used, which are not designed for coupling of the electromagnetic waves, e.g. by size of the fibers or shielding by means of coatings or shielding by means of further fibers.
